(19) United States
(12) Patent Application Publication
(10) Pub. No.: US 2022/0102767 A1
(43) Pub. Date: Mar. 31, 2022

(54) SYSTEMS AND METHODS FOR CHARGING BATTERY PACKS VIA A CHARGER MODULE

(71) Applicant: Hilti Aktiengesellschaft, Schaan (LI)

(72) Inventors: Benjamin BOHM, Weilheim (DE); Martin SPIEGLER, Purgen OT Lengenfeld (DE); Marc ESQUIUS-SERRA, Bludenz (AT); Dheerendra PAWAR, Landsberg am Lech (DE)

(21) Appl. No.: 17/545,760

(22) Filed: Dec. 8, 2021

Related U.S. Application Data
(63) Continuation of application No. 17/542,770, filed on Dec. 6, 2021.
Application No. 17/542,770 is a continuation of application No. PCT/EP2020/083081, filed on Nov. 23, 2020.
(60) Provisional application No. 62/943,581, filed on Dec. 4, 2019.

(51) Int. Cl. H01M 10/42; H01M 10/44; H02J 7/00

(52) U.S. Cl. CPC H01M 10/4257; H01M 10/441; H01M 2010/4278; H02J 7/0044; H02J 7/00034

(57) ABSTRACT

A system includes a communications module comprising a first interface and a second interface, where the first interface is on an opposite surface of the communications module from the second interface. The system includes battery packs configured to receive power tool operating information from power tools, wherein the battery packs are configured to removably couple with the communications module via the second interface, and wherein the battery packs transfer a portion of the power tool operating information and/or a portion of battery pack operating information to the communications module via the second interface. The system includes a charger module configured to removably couple with the communications module via the first interface, where the charger module recharges the battery packs through the first and second interfaces of the communications module.

### CROSS-REFERENCE TO RELATED APPLICATIONS

This patent application is a continuation of International Patent Application No. PCT/EP2020/083081, filed Nov. 23, 2020, which claims the benefit of U.S. Provisional Application No. 62/943,581, filed Dec. 4, 2019, which are each incorporated by reference.

### BACKGROUND

The present disclosure relates generally to the field of power tools, and more particularly to a communications device within a charging device for use within a tool system.

Electrical devices, such as corded or cordless power tools, may be useful in typical construction job sites. Typically, electrical devices include a motor drive and control circuitry for controlling the motor drive. Certain corded power tools may draw power from a fixed power source, while certain cordless power tools may draw power from a rechargeable power source (e.g., rechargeable battery pack). In certain situations, it may be beneficial to have wireless communications between the power tool and various other components on the construction job site and/or to remote computing devices. However, some power tools may not be equipped with such wireless communications.

Accordingly, it may be beneficial to provide systems and methods for communications for use within a power tool system. Specifically, it may be beneficial to provide for systems and methods for a communications device that transmits information obtained from the power tool to other components on the construction job site and/or to remote computing devices.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In a first embodiment, a system includes a battery pack to receive power tool operating information and to gather battery pack operating information. The system also includes a communications module having a first interface and a second interface. The communications module removably couples with the battery pack via the first interface, and the communication module receives a portion of the power tool operating information and/or a portion of the battery pack operating information via the first interface. The communications module transmits the received information to a cloud-based computing device via a cellular transceiver.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an embodiment of a power tool system having a power tool, a battery pack, a charger module for charging the battery pack, and a communications device within a communications module for transmitting information obtained from the battery pack to a cloud-based computing device, in accordance with aspects of the present disclosure;

FIG. 2 is a block diagram of an embodiment of the power tool system of FIG. 1, where the power tool system includes one or more battery packs utilized with a communications module, in accordance with aspects of the present disclosure;

FIG. 3 is a schematic of an embodiment of circuitry of the communications module of FIG. 1, in accordance with aspects of the present disclosure;

FIG. 4 is an embodiment of a method for transmitting information obtained from the battery pack to a cloud-based computing device via the communications device of FIG. 1, in accordance with aspects of the present disclosure;

FIG. 5 is an embodiment of a method for transmitting a command signal from the cloud-based computing device to the battery pack via the communications device of FIG. 1, in accordance with aspects of the present disclosure;

FIG. 6 is an embodiment of a method for transmitting a confirmation signal from the battery pack to the cloud-based computing device via the communications device of FIG. 1, in accordance with aspects of the present disclosure; and

FIG. 7 is a block diagram of an embodiment of the power tool system of FIG. 1, where the charger module for charging the battery pack includes the communication device for transmitting information obtained from the battery pack to the cloud-based computing device, in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

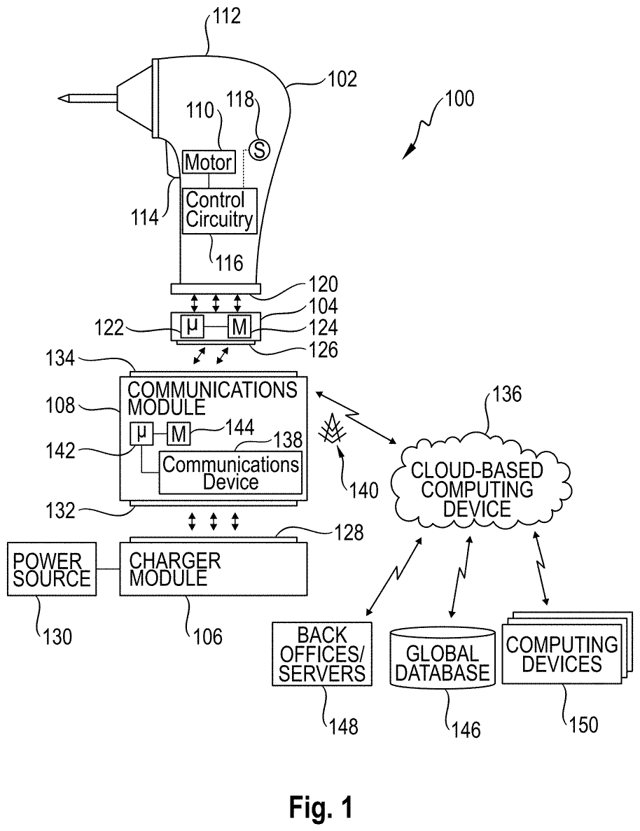

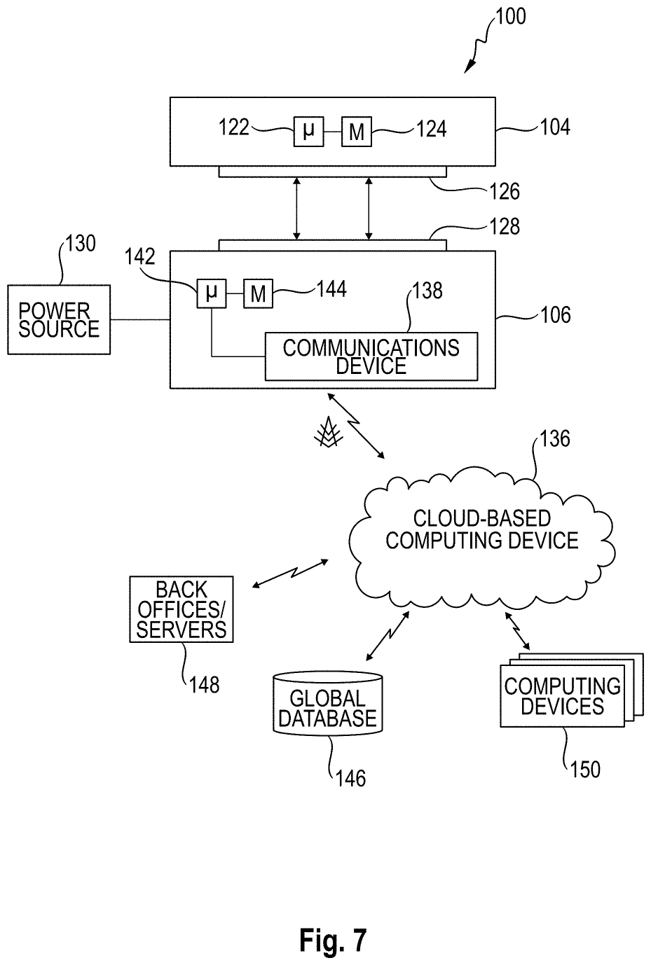

Present embodiments are directed to a communications device configured for use within a power tool system on a construction job site. Specifically, the communications device is configured to obtain information about the power tool, and then transmit the obtained information to other components on the construction job site and/or to remote computing devices (e.g., a cloud-based computing device). In certain embodiments, the communications device is a cellular transceiver that transmits the obtained information via a cellular antenna to a cloud-based computing device. In certain embodiments, the communications device receives command signals from remote computing devices (e.g., the cloud-based computing device), and transmits the command signals to the battery pack. In certain embodiments, the communications device may be disposed within a separate communications module that is configured to removably couple with a battery pack and a charging module, as illustrated and further described with respect to FIGS. 1-3. In certain embodiments, the communications device may be disposed within the charging module that is configured to removably couple with the battery pack, as illustrated and further described with respect to FIG. 7.

Turning now to the drawings, FIG. 1 is a block diagram of an embodiment of a power tool system 100 having a power tool 102, a battery pack 104, a charger module 106, and a communications module 108. In the illustrated embodiment, the communications module 108 includes a communications device 138 (e.g., cellular transceiver). However, it should be noted that the communications device 138 may be disposed within other components of the power tool system 100, such as the charging module 106, as illustrated and described with respect to FIG. 7. In certain embodiments, the power tool 102 may be a cordless power tool configured to receive power from the battery pack 104. In certain embodiments, the power tool 102 includes a motor 110, a housing assembly 112, a trigger 114, and control circuitry 116 that is configured to control one or more components of the power tool 102. In certain embodiments, the power tool 102 includes one or more sensors 118, such as, for example, safety sensors, position and/or orientation sensors, touch sensors, pressure sensors, accelerometers, temperature sensors, proximity and displacement sensors, image sensors, level sensors, gyroscopes, force sensors, speed sensors, etc. The one or more sensors 118 may be configured to gather operating information about the power tool 102.

The battery pack 104 may be removably coupled with the power tool 102 via a tool interface 120. In the illustrated embodiment, the motor 107 is configured to receive power from the removably coupled power device 106, thereby enabling the power tool 104 with a cordless capability. In certain embodiments, the trigger 114 and the motor 110 may be communicatively coupled to the control circuitry 116, and engaging various functions of the trigger 114 may enable functionality of the power tool 102. For example, engaging the “ON” or “OFF” features of the trigger 114 may provide an input to the control circuitry 116, which in turn may provide a drive signals to the motor 110.

In certain embodiments, engaging the “ON” or “OFF” features of the trigger 114 may indicate to the control circuitry 116 to transmit operational information related about the power tool 102 to the battery pack 104. Specifically, the information may be communicated via a wired connection through the tool interface 120. For example, in certain embodiments, upon engaging the trigger 114 to turn “OFF” the power tool 102, the control circuitry 116 may be configured to transmit operating parameters related to the power tool 102 to the battery pack 104. As a further example, in certain embodiments, upon engaging the trigger 114 to turn “ON” the power tool 102, the control circuitry 116 may be configured to transmit operating parameters related to the power tool 104 to the battery pack 104. In certain embodiments, sensor feedback from the one or more sensors 118 (e.g., a touch wake-up detected by the sensor 118) may result in tool “wake-up,” causing the control circuitry 116 to transmit operating parameters related to the power tool 102 to the battery pack 104.

In certain embodiments, operating parameters related to the power tool 102 may include, but are not limited to, unique identification information related to the power tool 102, unique identification information related to the manufacturer, owner, and/or previous owners of the power tool 102, historical information related to the operation of the power tool 102 (e.g., runtime), error codes or alerts triggered by the power tool 102, historical information related to the repair and/or theft of the power tool 102, sensor related information gathered from one or more sensors 118 disposed throughout the power tool 102, information related to the components of the power tool 102, drive signals provided by the control circuitry 116 and/or input signals provided by the trigger 114, and/or the general state of the health of the power tool 102.

In certain embodiments, the housing assembly 112 may include a housing body, a handle, and the tool interface 120 between the power tool 102 and the battery pack 104. As noted above, in certain embodiments, the battery pack 104 may be a rechargeable battery pack that is removably coupled to the power tool 102 via the tool interface 120. The rechargeable battery pack may be a lithium-ion battery pack of various specifications. In particular, the battery pack 104 may be an interchangeable device, that may be configured for use with a plurality of power tools. The interface 120 may enable the battery pack 104 to be communicatively coupled to the power tool 102. For example, the interface 120 may include one or more contact points that allow power to be transferred between the battery pack 104 and the power tool 102. Further, the tool interface 120 may include one or more contact points that allow the transfer of information (e.g., communications) between the control circuitry 116 of the power tool 102 and the battery pack 104.

In certain embodiments, the battery pack 104 may include control circuitry 122 and communications circuitry. In certain embodiments, the control circuitry 122 of the battery pack 104 receives operating parameter information related to the power tool 102 from the control circuitry 116 of the power tool 102. Further, in certain embodiments, the control circuitry 122 of the battery pack 104 may gather operating parameter information related to the battery pack 104, such as, but not limited to, unique identification information related to the battery pack 104, historical information related to the operation of the battery pack 104 (e.g., cycles of operation, remaining power, etc.), state of health (SOH) status and/or state of charge (SOC) status of the battery pack 104, error codes triggered by the power tool 102, and/or status of the battery pack 104 (e.g., battery lock down status). Accordingly, in certain embodiments, the communications circuitry 122 may store operation information related to both the power tool 102 and the battery pack 104 within the memory 124.

In certain embodiments, the battery pack 104 may be removably coupled to the charger module 106 to recharge the battery pack 104. In certain embodiments, the battery pack 104 may include a battery interface 126 that is configured to removably couple with the charger module interface 128 of the charging module 106. In certain embodiments, the interfaces 126, 128 may include one or more features that help guide, engage, or secure the battery pack 104 to the charging module 106. The one or more features may include various ridges, rails, guides, tabs, buttons, clips, or any other fastening or securing features known in the art to securely and removably couple the battery pack 104 to the charging module 106. In certain embodiments, the charger module 106 may be utilized with one or more battery packs 104. The battery pack 104 may be configured to receive power through the charging interfaces 126, 128. In turn, the charger module 106 may be configured to receive power via a power source 130, such as a power outlet and/or direct power source.

In certain embodiments, the communications module 108 may be removably disposed between the battery pack 104 and the charger module 106. In certain embodiments, the communications module 108 may include the communications device 138 (e.g., cellular transceiver), such that it is a stand-alone device. In particular, the communications module 108 having the communications device 138 may be utilized with one or more different battery packs 104 and may be configured as a retroactive device. The communications module 108 may be removably coupled to the charger module 106 through the charger module interface 128. In certain embodiments, the communications module 108 may include a first interface 132 and a second interface 134. The first interface 132 may be configured to removably couple with the charger module 106 via the charger module interface 128. The second interface 134 may be configured to removably couple with the battery pack 104 via the battery interface 126. As noted above, the interfaces 132, 134 may include one or more features that help guide, engage, or secure the battery pack 104 and the charger module 106 to the communications module 108. The one or more features may include various ridges, rails, guides, tabs, buttons, clips, or any other fastening or securing features known in the art to securely and removably couple the battery pack 104 and/or the charging module 106 to the communications module 108. It should be noted that in certain embodiments, the battery interface 126 may be substantially similar to the first interface 132, such that either the battery interface 126 or the first interface 132 may removably couple with the charger module 106 in a similar manner. In certain embodiments, the battery interface 126 may be identical to the first interface 132, such that either the battery interface 126 or the first interface 132 may removably couple with the charger module 106 in the same manner.

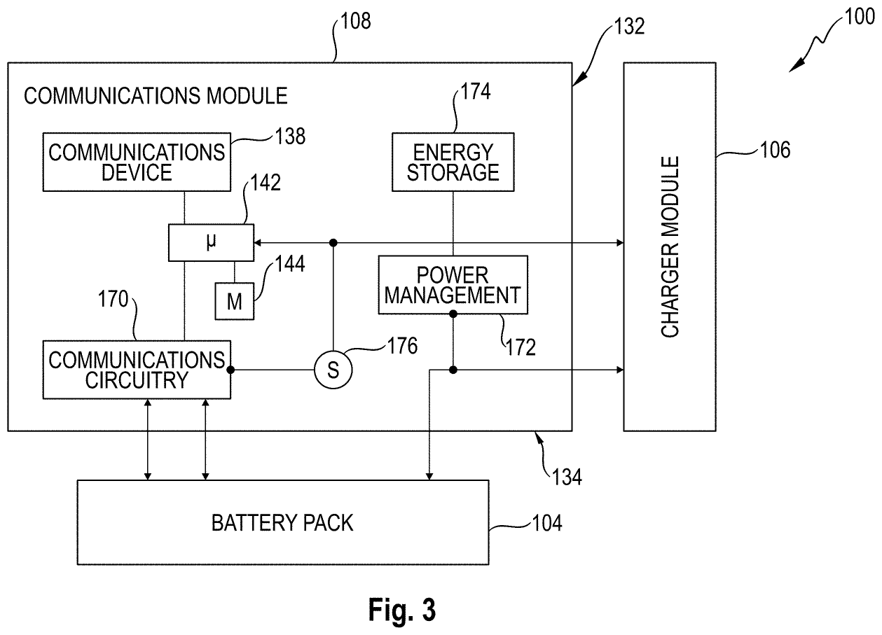

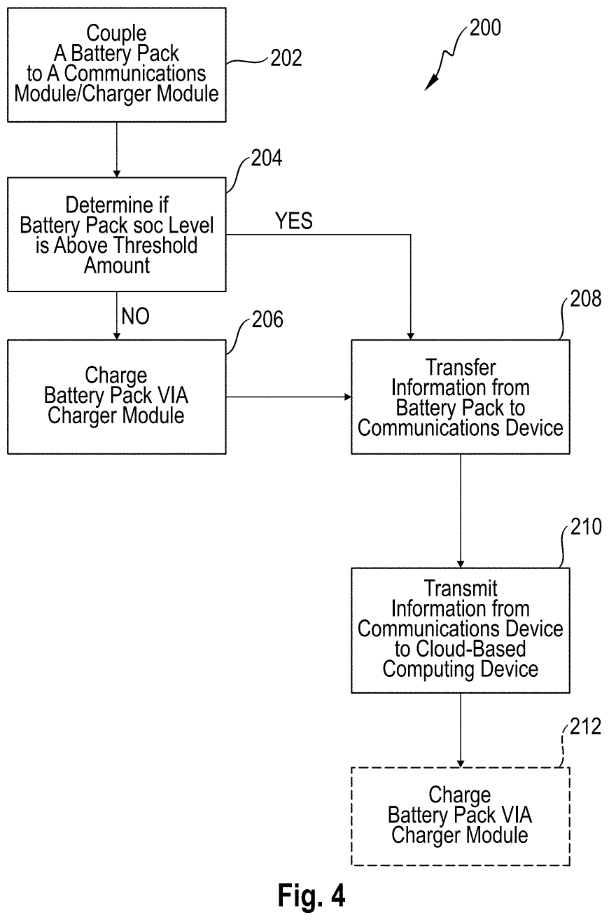

Accordingly, the communications module 108 having the communications device 138 may be configured as a retroactive device configured to couple to a charging device for battery packs 104. In particular, the communications module 108 may include one or more terminals or contact points to transfer information (e.g., communications) through a wired connection between the battery pack 104 and the communications module 108, as further described with respect to FIG. 4. Further, in certain embodiments, the communications module 108 may include one or more terminals or contact points to transfer power to the battery pack 104 via the communications module 108, as further described with respect to FIG. 3.

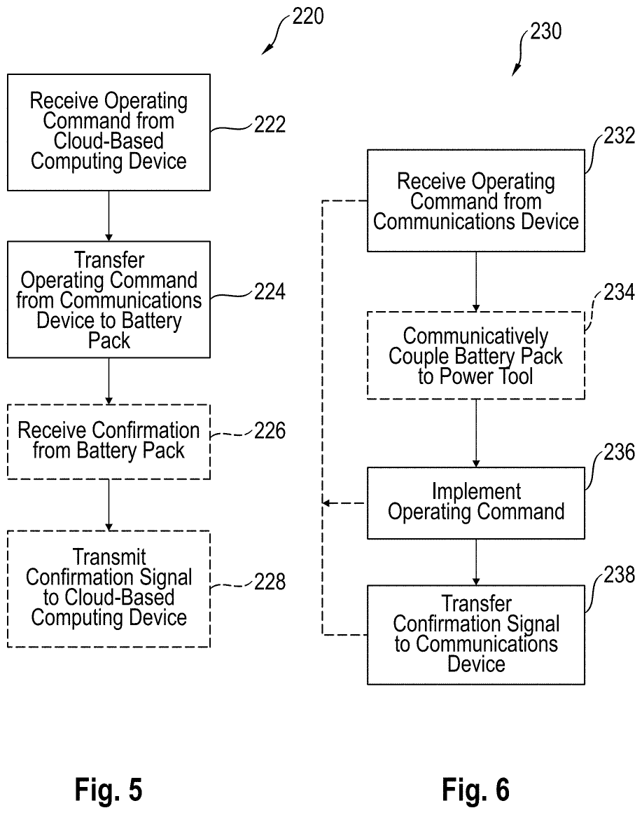

After receiving information from one or more battery packs 104, the communications module 108 may store, process or transmit the information. For example, in certain embodiments, the communications module 108 may be configured to transmit the information (e.g., operating parameters related to the power tool 102 and/or operating parameter information related to the battery pack 104) to a cloud-based computing device 136 via a communications device 138 (e.g., cellular transceiver) of the communications module 108 and an antenna 140. By utilizing cellular communications, the communications module 108 may omit various additional devices on the construction site typically used as a gateway, such as a mobile phone, tablet, computer or other processor-enabled devices that act as a gateway. Further, while the following embodiments are described with respect to cellular communications, it should be noted that other forms of wireless communications may be utilized to transmit information to the cloud-based computing device 136, such as satellite, UHF, VHF, WLANs, Wi-Fi, and so forth. In certain embodiments, the cloud-based computing device 136 may be configured to transmit command signals to the communications module 108, which may be transferred to and implemented within the battery pack 104, as further described with respect to FIGS. 5-6.

In certain embodiments, the communications module 108 may include a processor 142 and a memory 144. The processor 142 may be configured to execute instructions stored on the memory 144 to carry out the functions of the communications module 108. The memory 144 may be configured to store instructions that are loadable and executable on the processor 142. In certain embodiments, the memory 144 may be volatile (such as a random access memory (RANI)) and/or non-volatile (such as read-only memory (ROM), flash memory, etc.). In some implementations, the memory 144 may include multiple different types of memory, such as static random access memory (SRAM), dynamic random access memory (DRAM), or ROM.

In certain embodiments, the cloud-based computing device 136 may be a service provider providing cloud analytics, cloud-based collaboration and workflow systems, distributed computing systems, expert systems and/or knowledge-based systems. In certain embodiments, the cloud-based computing device 136 may be a data repository that is coupled to an internal or external global database 146. Further, in certain embodiments, the global database 146 may allow computing devices 150 to retrieve information stored within for additional processing or analysis. Indeed, the cloud-based computing device may be accessed by a plurality of systems (computing devices 150 and/or computing devices from back offices/servers 148) from any geographic location, including geographic locations remote from the physical locations of the systems. Accordingly, the cloud 136 may enable advanced collaboration methods between parties in multiple geographic areas, provide multi-party workflows, data gathering, and data analysis, which may increase the capabilities the power tool 102.

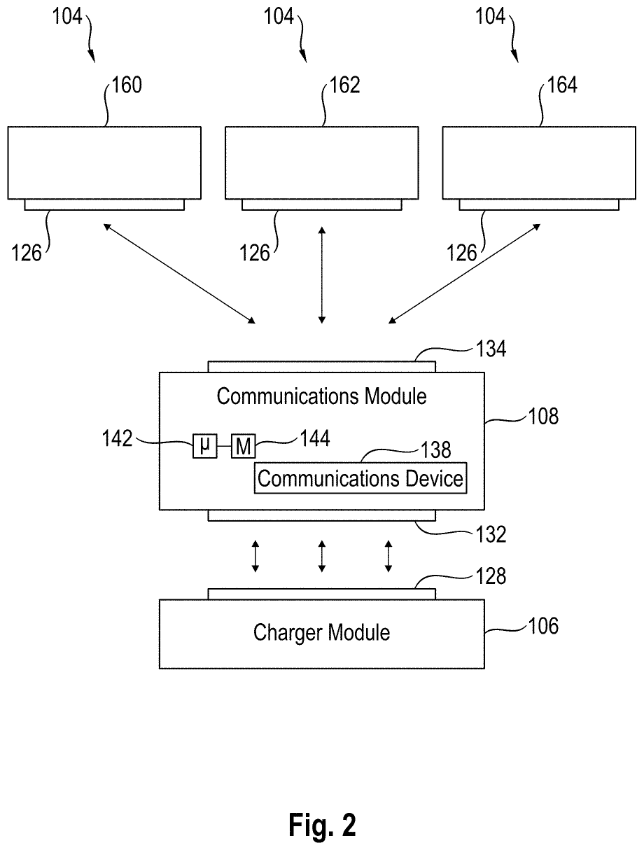

FIG. 2 is a block diagram of an embodiment of the power tool system 100 of FIG. 1, where the power tool system 100 includes one or more battery packs 104 utilized with the same communications module 108, in accordance with aspects of the present disclosure. As noted above, in certain embodiments, the battery pack 104 may include a battery interface 126 that is configured to removably couple with the charger module interface 128 of the charging module 106. In particular, one or more battery packs 104 (which may correlate to one or more different power tools 102) may be utilized with the same charger module 106. In this manner, one charger module 106 may be utilized to charge, at different times, a plurality of battery packs 104.

As noted above, in certain embodiments, the communications module 108 having the communications device 138 (e.g., the cellular transceiver) may be may be removably disposed between the battery pack 104 and the charger module 106. The first interface 132 may be configured to removably couple with the charger module 106 via the charger module interface 128, and the second interface 134 may be configured to removably couple with the battery pack 104 via the battery interface 126. The communications module 108 may have bi-directional communications with the battery pack 104 via a wired connection. In particular, in certain embodiments, the one or more battery packs 104 may be utilized with the same communications module 108. For example, in the illustrated embodiment, a first battery pack 160, a second battery pack 162, and a third battery pack 164 may be removably coupled, at different times, with the same communications module 108.

Furthermore, in certain embodiments, each of the battery packs 104 (e.g., the first battery pack 160, the second battery pack 162, and the third battery pack 164) may be configured to transfer information to the communications module 108. Accordingly, in certain embodiments, the communications module 108 may be configured to store information (e.g., operating parameters related to the power tool 102 and/or operating parameter information related to each battery pack 104) within the memory 144. In particular, the communications module 108 may associate the information stored with the specific power tool 102 and battery pack 104 combination. Further, the communications module 108 may be configured to transmit this information to the cloud-based computing device 136 via the communications device 138 (e.g., cellular transceiver) and the antenna 140.

FIG. 3 is a schematic of an embodiment of circuitry of the communications module 108 of FIG. 1, in accordance with aspects of the present disclosure. In the illustrated embodiment, the communications module 108 includes the communications device 138 (e.g., cellular transceiver). Accordingly, in the illustrated embodiment, the communications module 108 is a stand-along device that may be configured as a retroactive communications device. However, it should be noted that the communications device 138 (e.g., cellular transceiver) may be disposed within other components of the power tool system 100, such as the charging module 106, as illustrated and described with respect to FIG. 7. In particular, the cellular transceiver may be configured to wirelessly communicate information via the cellular antenna, without the need for a gateway device.

In certain embodiments, the communications module 108 may include communications circuitry 170, power management circuitry 172, an energy storage 174, and a switch 176. As noted above, the communications module 108 may include the first interface 132 to removably couple with the charger module 106, and the second interface 134 to removably couple with the battery pack 104. As noted above, the interfaces 132, 134 may include one or more features that help guide, engage, or secure the battery pack 104 and the charger module 106 to the communications module 108. The one or more features may include various ridges, rails, guides, tabs, buttons, clips, or any other fastening or securing features known in the art to securely and removably couple the battery pack 104 and/or the charging module 106 to the communications module 108. In particular, the interfaces 132, 134 may include one or more terminals utilized to transfer power and/or information via wired connections. For example, the battery pack 104 may be configured to transfer information via the terminals to the communications circuitry 170 of the communications module 108. As a further example, the battery pack 104 may be configured to receive power via the terminals from the charger module 106. In particular, in certain embodiments, the battery pack 104 may receive power through the communications module 108, such as when the communications module 108 is removably coupled (and disposed between) to both the battery pack 104 and the charger module 106.

In certain embodiments, the communications module 108 includes the power management circuitry 172 to monitor the transfer of power from the charger module 106 to the battery pack 104. In certain embodiments, the power management circuitry 172 may be configured to determine the SOC or status of the battery pack 104 when the battery pack 104 is removably coupled to the communications module 108. This information may be utilized to determine whether the battery pack 104 is capable of transferring information to the communications circuitry 170 or whether the battery pack 104 needs to be recharged prior to the transfer of information. The power management circuitry 172 may also be configured to monitor the energy storage 174 of the communications module 108.

In certain embodiments, the switch 176 may be configured to regulate whether the communications module 108 is configured to transfer information from the battery pack 104 to the communications circuitry 170 or transfer power from the charger module 106 to the battery pack 104. For example, when the switch is “CLOSED,” the charger module 106 may charge or recharge the battery pack 106, and when the switch is “OPEN,” the battery pack 104 may transfer information to the communications circuitry 170. In certain embodiments, the processor 142 determines whether the switch 176 should be “OPEN” or “CLOSED,” based at least in part on the SOC of the battery pack 104. Accordingly, the communications module 108 may be able to regulate the transfer of power and information to desired times.

FIG. 4 is an embodiment of a method 200 for transmitting information obtained from the battery pack 104 to the cloud-based computing device 136 via the communications device 138 of FIG. 1, in accordance with aspects of the present disclosure. The method 200 includes coupling the battery pack 104 to the communications module 108 (block 202). In certain embodiments, the method 200 includes coupling the battery pack 104 directly the charger module 106, which may include the communications device 138, as further described with respect to FIG. 7. The coupling may include guiding the battery interface 126 to mate with the second interface 134 via one or more features that that help guide, engage, or secure the battery pack 104 and the charger module 106 to the communications module 108. The one or more features may include various ridges, rails, guides, tabs, buttons, clips, or any other fastening or securing features known in the art to securely and removably couple the battery pack 104 to a charging device.

In certain embodiments, the method 200 also includes determining if the battery pack 104 has a State of Charge (SOC) level that is above a predetermined threshold (block 204). In certain embodiments, before information is transferred from the battery pack 104 to the communications module 108, it may be beneficial to determine whether the battery pack 104 has enough charge to complete the information transfer process. In certain embodiments, if the SOC levels are below the predetermined threshold, the method 200 includes charging the battery pack 104 via the charger module 106 (block 206).

In certain embodiments, after charging the battery pack 104 (or if the battery pack 104 has a SOC level higher than the pre-determined thresholds), the method 200 includes the battery pack 104 transferring information from the battery pack 104 to the communications module 108 (or the communications device 138) (block 208). The information may be transferred through a wired connection between the battery interface 126 and the second interface 134. As noted above, the battery pack 104 may be configured to transmit operating parameters related to the power tool 102 and/or operating parameter information related to the battery pack 104 to the communications module 108. Further, in certain embodiments, the communications module 108 may be configured to store information transferred from multiple battery packs 104, as described above with respect to FIG. 2.

In certain embodiments, the method 200 includes transmitting the information (e.g., operating parameters related to the power tool 102 and/or operating parameter information related to the battery pack 104) to the cloud-based computing device 136 via the communications device 138 (e.g., cellular transceiver) of the communications module 108 and the antenna 140 (block 210). In particular, by including cellular communication capabilities within the communications module 108, the tool system 100 may operate without devices traditionally needed to transmit information to a remote cloud-based computing device (such as mobile phones, tablets, computers or other processor-enabled devices that act as a gateway). Further, in certain embodiments, the method 200 includes charging the battery pack 104 via the charger module 106 (block 212). In certain embodiments, the battery pack 104 may be charged at any point after the battery pack 104 is coupled to the communications module 106. For example, in certain embodiments, the battery pack 104 may be charged with the charger module 106 (through the communications module 106) after the battery pack 104 has transferred information to the communications module 108 and before the communications module 108 transmits information to the cloud-based computing device 136.

FIG. 5 is an embodiment of a method 220 for transmitting a command signal from the cloud-based computing device 136 to the battery pack 104 via the communications module 108 of FIG. 1, in accordance with aspects of the present disclosure. The method 220 includes the communications module 208 receiving a command signal from the cloud-based computing device 136 (block 222). For example, in certain embodiments, the cloud-based computing device 136 may send various command signals to the battery pack 104 via the communications module 108. These command signals may be generated based in part on the information received from the communications module 108 about the battery pack 104 and/or the power tool 102. For example, if the information is indicative of a potential problem (e.g., malfunction, theft, etc.), the cloud-based computing device 136 may be configured to send a lockdown command signal to lockdown the battery pack 104 and prevent further operations. The command signals may be an operating command that control or regulate an operating parameter of the power tool 102 and/or the battery pack 104. For example, the command signal may include lockdown commands and/or unlock commands for the battery pack 104, a block command, a shutdown or startup command, firmware updates for the communications module 108, exchange of security certificates, confirmation parameters, etc.

In certain embodiments, upon receiving the command signal, the method 220 includes the communications module 108 (or the communications device 138) transferring the command signal to the battery pack 104 (block 224). If the battery pack 104 of interest is not coupled to the communications module 108 at the time the communications module 108 receive the command signal, the communications module 108 may be configured to store the command signal until a future transfer time. In certain embodiments, the method 220 includes the communications module 108 receiving a confirmation signal from the battery pack 104 indicating that the command signal was properly received (block 226). Further, in certain embodiments, the communications module 108 may be configured to transmit the confirmation signal to the cloud-based computing device 136 to inform the cloud-based computing device 136 of a successful delivery (block 228).

FIG. 6 is an embodiment of a method 230 for transmitting a confirmation signal from the battery pack 104 to the cloud-based computing device 136 via the communications module 108 of FIG. 1, in accordance with aspects of the present disclosure. The method 230 includes battery pack 104 receiving a command signal from the communication module 108 (or the communications device 138) (block 232). The command signals may be an operating command that control or regulate an operating parameter of the power tool 102 and/or the battery pack 104. For example, the command signal may include lockdown commands and/or unlock commands for the battery pack 104, a block command, a shutdown or startup command, firmware updates for the communications module 108, exchange of security certificates, confirmation parameters, etc.

In certain embodiments, the battery pack 104 may be configured to directly implement the command signal (block 236) if the command signal is related to the operation of the battery pack 104. In certain embodiments, the battery pack 104 may be configured to store the command signal within the memory 124 until the battery pack 104 is communicatively coupled to the power tool 102 (block 234). In such instances, the battery pack 104 and/or the power tool 102 may be configured to implement the command signal when the command signal is related to the operation of the power tool 102 and/or both the power tool 102 and the battery pack 104. In certain embodiments, after implementing the command signal, the battery pack 104 may be configured to transfer a confirmation signal to the communications module 108 (or the communications device 138) (block 238). In certain embodiments, the battery pack 104 may be configured to transfer a confirmation signal upon receiving the command signal. In certain embodiments, the battery pack 104 may be configured to transfer a confirmation signal upon receiving and implementing the command signal. In certain embodiments, the battery pack 104 may be configured to transfer a confirmation signal upon receiving and successfully implementing the command signal.

FIG. 7 is a block diagram of an embodiment of the power tool system 100 of FIG. 1, where the charger module 106 for charging the battery pack 104 includes the communications device 138. As noted above, the communications device 138 may be configured for transmitting information obtained from the battery pack 104 to the cloud-based computing device 136. For example, the communications device 138 may be a cellular transceiver configured to transmit information (e.g., operating parameters related to the power tool 102 and/or operating parameter information related to the battery pack 104) to the cloud-based computing device 136 via the cellular antenna. In particular, the communications device 138 may reduce or omit the need for a gateway device typically utilized to transmit information to a remote computing device.

In certain embodiments, the communications device 138 may be disposed within the charger module 106, such that the charger module 106 receives and transmits information. For example, the charger module 106 may be configured to receive information directly from the battery pack 104, such as when the battery pack 104 is removably coupled to the charger module 106 to be charged or recharged. As noted above, the battery pack 104 may include the battery interface 126 that is configured to removably couple with the charger module interface 128 of the charging module 106. In certain embodiments, the interfaces 126, 128 may include one or more features that help guide, engage, or secure the battery pack 104 to the charging module 106. The one or more features may include various ridges, rails, guides, tabs, buttons, clips, or any other fastening or securing features known in the art to securely and removably couple the battery pack 104 to the charging module 106. Further, in certain embodiments, when the charger module 106 is directly and removably coupled to the battery pack 104, the interfaces 126, 128 may include one or more terminals configured to transfer both power and information. As described with respect to FIGS. 4-6, the communications device 138 may interact with the battery pack 104 to receive and transfer operating information, operational commands or confirmation signals, and/or power.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1-15. (canceled)

16. A system, comprising:
a communications module comprising a first interface and a second interface, wherein the first interface is on an opposite surface of the communications module from the second interface;
a first battery pack configured to receive a first power tool operating information from a first power tool, wherein the first battery pack is configured to removably couple with the communications module via the second interface, and wherein the first battery pack transfers a portion of the first power tool operating information and/or a portion of a first battery pack operating information to the communications module via the second interface;
a second battery pack configured to receive a second power tool operating information from a second power tool, wherein the second battery pack is configured to removably couple with the communications module via the second interface, and wherein the second battery pack transfers a portion of the second power tool operating information and/or a portion of a second battery pack operating information to the communications module via the second interface; and
a charger module configured to removably couple with the communications module via the first interface, wherein the charger module recharges the first and second battery packs through the first and second interfaces of the communications module.

17. The system of claim 16, wherein the communications module stores the first and second power tool operating information.

18. The system of claim 16, wherein the communications module is configured to transmit the first and second power tool operating information to a cloud-based computing device.

19. The system of claim 16, wherein the communications module is configured to transmit the first and second battery pack operating information to a cloud-based computing device.

20. The system of claim 16, wherein the communications device is a cellular transceiver configured to transmit the received information via a cellular antenna.

21. The system of claim 16, wherein the first battery pack is configured to receive power tool operating information from one or more power tools, store the power tool operating information, and transfer the power tool operating information to the communications module.

22. The system of claim 16, wherein the first and the second power tool operating information comprises unique identification information related to the first and second power tools or unique identification information related to the manufacturer, owner, and/or previous owners of the power tools, or a combination thereof.

23. The system of claim 16, wherein the first and the second power tool operating information comprises historical information related to the operation of the first and second power tools (e.g., runtime), historical information related to the repair and/or theft of the power tools, historical information related to error codes or alerts triggered by the power tools, or a combination thereof.

24. The system of claim 16, wherein the first and the second power tool operating information comprises sensor related information gathered from one or more sensors disposed throughout the first and second power tools, information related to tool components of the power tools, or a combination thereof.

25. The system of claim 16, wherein the first and the second battery pack operating information includes unique identification information related to the first and second battery packs, historical information related to the operation of the battery packs, cycles of operation, a power level, a state of health (SOH) status, a state of charge (SOC) status, historical information related to error codes, a lockdown status, a unlock status, or a combination thereof.

26. The system of claim 16, wherein the first and second battery packs are a rechargeable battery packs comprising a series of rechargeable battery cells.
